(19) United States
(12) Patent Application Publication
(10) Pub. No.: US 2008/0011322 A1
(43) Pub. Date: Jan. 17, 2008

(54) Cleaning systems and methods

(76) Inventors: Frank Weber, Egmating (DE); Marcus Culmsee, Wappingers Falls, NY (US)

Correspondence Address: SLATER & MATSIL LLP, 17950 PRESTON ROAD, SUITE 1000, DALLAS, TX, 75252, US

(21) Appl. No.: 11/484,231

(22) Filed: Jul. 11, 2006

(51) Int. Cl. C23G 1/00; B08B 3/00

(52) U.S. Cl. 134/2; 134/26; 134/34; 134/94.1; 134/198

(57) ABSTRACT

Cleaning systems and methods are provided. A preferred embodiment comprises a method of cleaning that includes providing a device and disposing a cleaning fluid on the device. The cleaning fluid includes a first component saturated with a second component. The first component comprises a liquid, and the second component comprises a material that is releasable from the cleaning fluid as a gas. The second component is caused to be released from the cleaning fluid while the cleaning fluid is disposed on the device.

### TECHNICAL FIELD

The present invention relates generally to the fabrication of semiconductor devices, and more particularly to cleaning systems and methods for semiconductor devices.

### BACKGROUND

Generally, semiconductor devices are manufactured by depositing many different types of material layers over a semiconductor workpiece or wafer. The material layers typically comprise thin films of conductive, semiconductive, and insulating materials that are patterned and etched using lithography to form integrated circuits (IC's).

After patterning a material layer, the material layer is typically cleaned to remove any photoresist or debris before the next material layer is deposited. After patterning, the layer of photoresist used as a mask to pattern the material layer is ashed and removed. For example, typically a material layer is rinsed with a detergent-containing solution and then rinsed with deionized water or other type of water.

In some semiconductor cleaning processes, a plurality of semiconductor wafers is placed in a cassette adapted to hold about 25 wafers, and the entire cassette is submerged into a cleaning solution, e.g., in a tank tool. This technique was an effective cleaning method in older generation semiconductor devices having wide and shallow features, and was advantageous in that many wafers could be cleaned at the same time.

Cleaning material layers of semiconductor devices in a tank tool typically involves flowing the cleaning liquid laterally across the surfaces of the wafers within the tank tool. However, the wafers are positioned closely together in the cartridge, and re-deposition of particles tends to occur within features of the semiconductor device. Because the lateral flow within the tank tool is ineffective in moving the cleaning fluid between the closely spaced wafers, the cleaning process is primarily driven by diffusion, in which concentration differences move the cleaning fluid between features of the semiconductor device, which is a slow process.

More recent cleaning systems and methods for semiconductor devices comprise spray tools, wherein a chuck adapted to support a single wafer is placed near a spray nozzle, from which a liquid is sprayed onto the wafer surface while the wafer is rotated. The lateral flow of the liquid on the top surface of the material being cleaned removes particle style contaminations and drives convection within features formed in the material layer.

There is a trend in the semiconductor industry to decrease the size of features, in order to meet the demands of improved performance in decreased power requirements as examples. However, as the minimum feature sizes of IC's are decreased, cleaning semiconductor devices becomes more difficult.

Thus, what are needed in the art are improved systems and methods for cleaning material layers of semiconductor devices.

### SUMMARY OF THE INVENTION

These and other problems are generally solved or circumvented, and technical advantages are generally achieved, by preferred embodiments of the present invention which provide novel cleaning systems and methods.

In accordance with a preferred embodiment of the present invention, a method of cleaning includes providing a device, and disposing a cleaning fluid on the device. The cleaning fluid includes a first component saturated with a second component. The first component comprises a liquid, and the second component comprises a material that is releasable from the cleaning fluid as a gas. The second component is caused to be released from the cleaning fluid while the cleaning fluid is disposed on the device.

The foregoing has outlined rather broadly the features and technical advantages of embodiments of the present invention in order that the detailed description of the invention that follows may be better understood. Additional features and advantages of embodiments of the invention will be described hereinafter, which form the subject of the claims of the invention. It should be appreciated by those skilled in the art that the conception and specific embodiments disclosed may be readily utilized as a basis for modifying or designing other structures or processes for carrying out the same purposes of the present invention. It should also be realized by those skilled in the art that such equivalent constructions do not depart from the spirit and scope of the invention as set forth in the appended claims.

### BRIEF DESCRIPTION OF THE DRAWINGS

For a more complete understanding of the present invention, and the advantages thereof, reference is now made to the following descriptions taken in conjunction with the accompanying drawings, in which:

FIG. 1 shows a cross-sectional view of a prior art cleaning method for a semiconductor device, wherein a lateral flow of a cleaning fluid is effective in creating a convection flow within a feature;

FIG. 2 is a cross-sectional view of a prior art cleaning method, wherein the lateral flow of the cleaning fluid is ineffective in creating adequate convection flow within a narrow feature;

FIG. 3 shows a cross-sectional view of a semiconductor device in accordance with an embodiment of the present invention, wherein a cleaning fluid comprises a saturated solution including component releasable from the solution as a gas, wherein after the cleaning fluid is applied on a surface of the semiconductor device, the gas is caused to be released from the cleaning fluid, creating a vertical flow of the cleaning fluid within features;

FIG. 4 shows a cleaning system in accordance with an embodiment of the present invention, wherein a change in pressure may be used to cause the gas to be released from the cleaning fluid;

FIG. 5 illustrates the cleaning system in accordance with another embodiment of the present invention, wherein an increase in temperature may be used to caused the gas to be released from the cleaning fluid;

FIG. 6 shows a cross-sectional view of a portion of the cleaning system shown in FIG. 5;

FIG. 7 shows a cleaning system in accordance with yet another embodiment of the present invention, wherein a plurality of semiconductor wafers may be cleaned simultaneously;.

FIG. 8 is a graph illustrating that the pressure may be fluctuated to cause the gas to be released from the cleaning fluid alternatingly with being caused to return into the saturated solution; and

FIG. 9 shows a cleaning system in accordance with another embodiment of the present invention, wherein the gas may be caused to be released from the cleaning fluid by changing the acidity of the cleaning fluid.

Corresponding numerals and symbols in the different figures generally refer to corresponding parts unless otherwise indicated. The figures are drawn to clearly illustrate the relevant aspects of the preferred embodiments and are not necessarily drawn to scale.

### DETAILED DESCRIPTION OF ILLUSTRATIVE EMBODIMENTS

The making and using of the presently preferred embodiments are discussed in detail below. It should be appreciated, however, that the present invention provides many applicable inventive concepts that can be embodied in a wide variety of specific contexts. The specific embodiments discussed are merely illustrative of specific ways to make and use the invention, and do not limit the scope of the invention.

The present invention will be described with respect to preferred embodiments in a specific context, namely in cleaning systems and methods for semiconductor devices. Embodiments of the present invention may also be applied, however, to other applications where it is desirable to clean devices with features having a very small size.

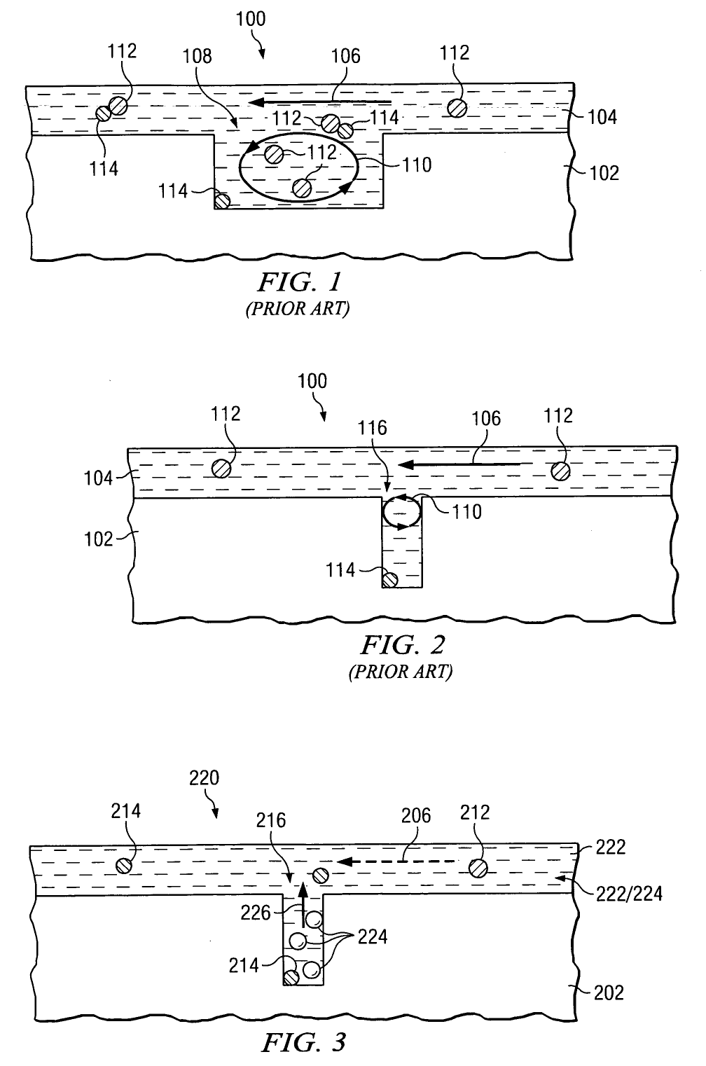

With reference now to FIG. 1, there is shown a cross-sectional view of a prior art cleaning method 100 for a semiconductor device 102, wherein a lateral flow 106 of a cleaning fluid 104 is effective in creating a convection flow 110 within a feature such as a trench 108. The semiconductor device 102 is patterned with a trench 108 that is relatively wide and shallow. When a cleaning fluid 104 is passed across a top surface of the semiconductor device 102 in a lateral direction 106 as shown, a convection flow 110 is formed within the trench 108. The convection flow 110 pushes the fluid down one sidewall of the trench 108, across the bottom surface of the trench 108, and back up the opposite sidewall of the trench 108. The convection flow 110 of the fluid 104 is effective in wide, shallow features 108 in removing debris 114 from within the trench 108.

The fluid 104 may include a detergent 112 that is adapted to attached to the debris 114, as shown, and the debris 114 attached to the detergent 112 is carried up and away out of the trench 108, to be carried away in the lateral flow 106 of the fluid 104 across the top surface of the device 102. The convection flow 110 is effective in delivering the detergent 112 to the bottom of the trench 108 to adhere with the debris 114 and move it to the top of the trench 108.

However, as features of devices 102 are decreased in size, a convection flow may not be created, or may only be created in the top of a trench. FIG. 2 is a cross-sectional view of a prior art cleaning method 100, wherein the lateral flow 106 of the cleaning fluid 104 is ineffective in creating an adequate convection flow within a narrow feature of a semiconductor device 102. The feature comprises a narrow trench 116 having a small width and a relatively large depth, as shown. The trench 116 may comprise a high aspect ratio, wherein the depth is significantly greater than the width of the trench 116, for example.

Because the trench 116 is narrow and deep, a convection flow 110 may only be formed in the top portion of the trench 116. The convection flow 110 does not extend to the bottom of the trench 116, thus making the removal of debris 114 difficult. Because there is no movement of the fluid 104 within the bottom of the trench 116, the removal of debris 114 from the lower portion of the trench 116 must be accomplished by diffusion of the debris 114 through the fluid 104. Diffusion relies on concentration differences for movement, which is a slow process, and may not result in the removal of all the debris 114. The detergent 112 in the fluid 104 may not reach the lower portion of the trench 116 in a high enough concentration, for example.

Furthermore, if the lateral flow 106 is too slow or too fast, a convection flow 110 may not be created within a trench 116 of a device 102 at all.

Thus, what are needed in the art are improved fluids, systems, and methods for cleaning devices having small, narrow features.

Embodiments of the present invention achieve technical advantages by providing novel fluids, systems, and methods for cleaning. The use of the novel cleaning fluids to be described herein force the transport of a cleaning fluid within narrow features, and thus provide improved cleaning methods.

FIG. 3 shows a cross-sectional view of a semiconductor device 202 in accordance with an embodiment of the present invention, wherein a cleaning method 220 includes providing a cleaning fluid 222/224 comprising a saturated solution including a first component 222 comprising a liquid and a second component 224 adapted to be released from the cleaning fluid 222/224 as a gas. The semiconductor device 202 includes a trench 216, as shown. Only one trench 216 is shown in FIG. 3; however, there may be a plurality, e.g., dozens, hundreds, or thousands of trenches 216 formed on the surface of the semiconductor device 202, not shown. Vertical features that extend past a top surface of the semiconductor device 202 may also reside on the surface of the semiconductor device 202, for example, also not shown.

The cleaning fluid 222/224 is applied on a surface of the semiconductor device 202, and the second component 224 is caused to be released from the cleaning fluid 222/224 as a gas, creating a vertical flow 226 of the cleaning fluid 222/224 within features, such as trench 216 formed in the semiconductor device 202. The upward movement or flow 226 of the second component 224 comprises bubbles of the gas that create a convection-like movement of the fluid 222/224. Advantageously, the gas bubbles of the second component 224 rise upwardly towards the top surface of the cleaning fluid 222/224, driving debris 214 towards the top surface of the cleaning fluid 222/224 and into the lateral flow 206 of the cleaning fluid 222/224 across the top surface of the semiconductor device 202.

The first component 222 of the cleaning fluid 222/224 preferably comprises a liquid. The first component 222 preferably includes a soap, a detergent, a solvent, distilled water, deionized water, water, or combinations thereof, as examples, although alternatively, the first component 222 may comprise other materials. The first component 222 may comprise a liquid used for cleaning away photoresist ash or debris, for example, if the cleaning fluid 222/224 is used in a first cleaning process after a layer of photoresist is removed from the semiconductor device 202. Alternatively, the first component 222 may comprise deionized water used for a second cleaning process, e.g., that is implemented after a first cleaning process using a liquid that contains a detergent.

The second component 224 preferably comprises CO₂, as an example, and may also comprise other materials that will release from or evaporate from the cleaning fluid 222/224 when a parameter of a cleaning system or the cleaning fluid 222/224 is changed. The second component 224 preferably comprises a material that is releasable from the cleaning fluid 222/224 as a gas upon a change in pressure, temperature, acidity, and/or upon agitation of the cleaning fluid 222/224, as examples, to be described further herein.

The second component 224 is preferably dissolved in the first component 222, in some embodiments. In some embodiments, the cleaning fluid 222/224 comprises a saturated solution, and in other embodiments, the cleaning fluid 222/224 preferably comprises an over-saturated solution of the first component 222 and the second component 224, for example.

The cleaning fluid 222/224 preferably comprises a second component 224 comprising a material that may comprise a gas state at predetermined temperatures (e.g., such as room temperature or greater) and pressures (e.g., such as 1 atm or greater), combined with a first component 224 comprising a fluid, such as water or a liquid typically used for cleaning semiconductor devices 202. In one embodiment, for example, the cleaning fluid 222/224 comprises H₂CO₃, as an example, wherein the first component 222 comprises H₂O and the second component comprises CO₂.

The cleaning fluid 222/224 may be formed by exposing the first component 222 to an environment comprising a gas of the second component 224. In some embodiments, the first component 222 is exposed to the gas of the second component 224 under pressure, e.g., within a pressurized container, to cause an increased amount of the second component 224 to dissolve in the first component 222, for example.

A method 220 of cleaning a device 202 in accordance with an embodiment of the present invention will next be described, with reference to FIG. 3. First, the device 202 is provided. The device 202 may comprise a semiconductor device 202 or other type of device. The semiconductor device 202 preferably comprises a workpiece. The workpiece 202 may include a semiconductor substrate comprising silicon or other semiconductor materials covered by an insulating layer, for example. The workpiece 202 may also include other active components or circuits, not shown. The workpiece 202 may comprise silicon oxide over single-crystal silicon, for example. The workpiece 202 may include other conductive layers or other semiconductor elements, e.g., transistors, diodes, etc. Compound semiconductors, GaAs, InP, Si/Ge, or SiC, as examples, may be used in place of silicon. The workpiece 202 may comprise a silicon-on-insulator (SOI) substrate, for example. Alternatively, the device 202 may comprise other devices or objects having very small features such as trenches 216 formed thereon, for example, not shown.

The cleaning fluid 222/224 is disposed on the device 202. Either before, during, or after (or combinations thereof) the cleaning fluid 222/224 is disposed on the device 202, at least a portion of the second component 224 is caused to be released from the cleaning fluid 222/224. Preferably, the second component 224 is caused to be released from the cleaning fluid 222/224 while the cleaning fluid 222/224 is disposed on the device, so that a plurality of bubbles of gas of the second component 224 assists in the cleaning of the semiconductor device 202.

Releasing the second component 224 from the cleaning fluid 222/224 forms a plurality of bubbles of the gas (e.g., comprising the second component 224 of the cleaning fluid 222/224) that move through the cleaning fluid 222/224 in an upward direction towards the top surface of the cleaning fluid 222/224. The device 202 may have a top surface having particles or debris 214 formed thereon, for example. The plurality of bubbles of gas comprising the second component 224 collides with the particles or debris 214, moving the particles and/or debris 214 in the upward direction 226. Portions of the first component 222 such as a detergent (not shown) may combine with the debris 214, further facilitating the removal of the debris 214.

Advantageously, the plurality of upwardly moving bubbles of gas comprising the second component 224 create a convection-like action, wherein as the bubbles of gas comprising the second component 224 move upwards, more of the cleaning fluid 222/224 moves downwardly in the trench 216 to replace the upwardly rising bubbles, creating a flow of the cleaning fluid 222/224 in and out of the bottom portion of the trench 216.

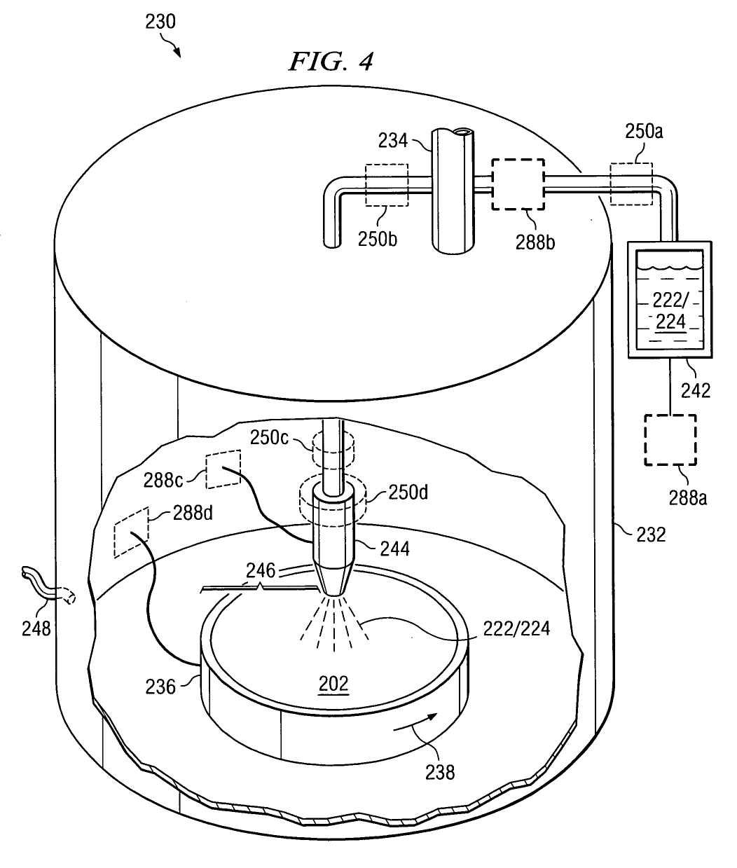

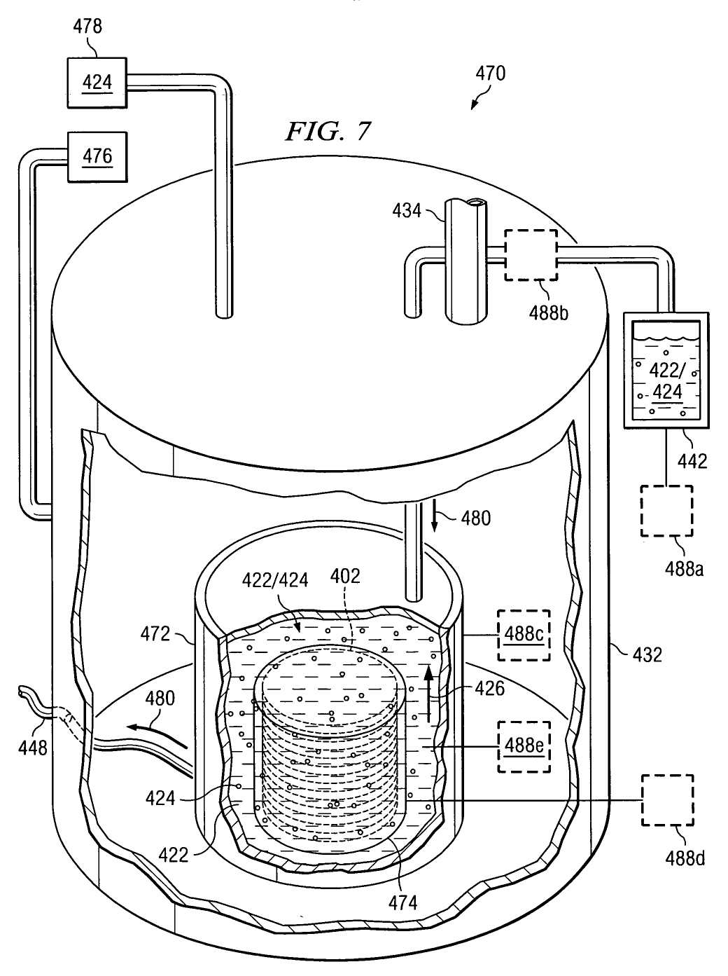

The cleaning fluid 222/224 is preferably applied to at least one surface of the device 202. For example, the cleaning fluid 222/224 may be sprayed on the device 202, as shown in FIGS. 4, 5, 6, and 9. Alternatively the device 202 may be immersed in the cleaning fluid 222/224, as shown in FIG. 7. The cleaning fluid 222/224 may also be applied using other methods, for example, not shown.

FIG. 4 shows a cleaning system 230 in accordance with an embodiment of the present invention, wherein a change in pressure may be used to cause the gas comprising the second component 224 to be released from the cleaning fluid 222/224. The cleaning system 230 comprises a container or chamber 242 adapted to hold a reserve or supply of the cleaning fluid 222/224. The container 242 is preferably adapted to be pressurized, in some embodiments. The container 242 is preferably adapted to pressurize the contents thereof from about one to five atm, as examples, although other pressure levels may also be used.

The cleaning system 230 also preferably comprises a chamber 232 wherein the cleaning of a device 202 (e.g., comprising a device such as semiconductor device 202 shown in FIG. 3) preferably takes place. The chamber 232 may include a vent 234 comprising a pipe or tube with an opening terminating at the chamber 232 coupled thereto, from which gases or other by-products from the cleaning process are emitted and are routed out of the chamber 232, as shown.

The chamber 232 is preferably pressurizable, in accordance with some embodiments of the present invention, for example. The chamber 232 is preferably adapted to pressurize the contents thereof from about one to five atm, as examples, although other pressure levels may also be used.

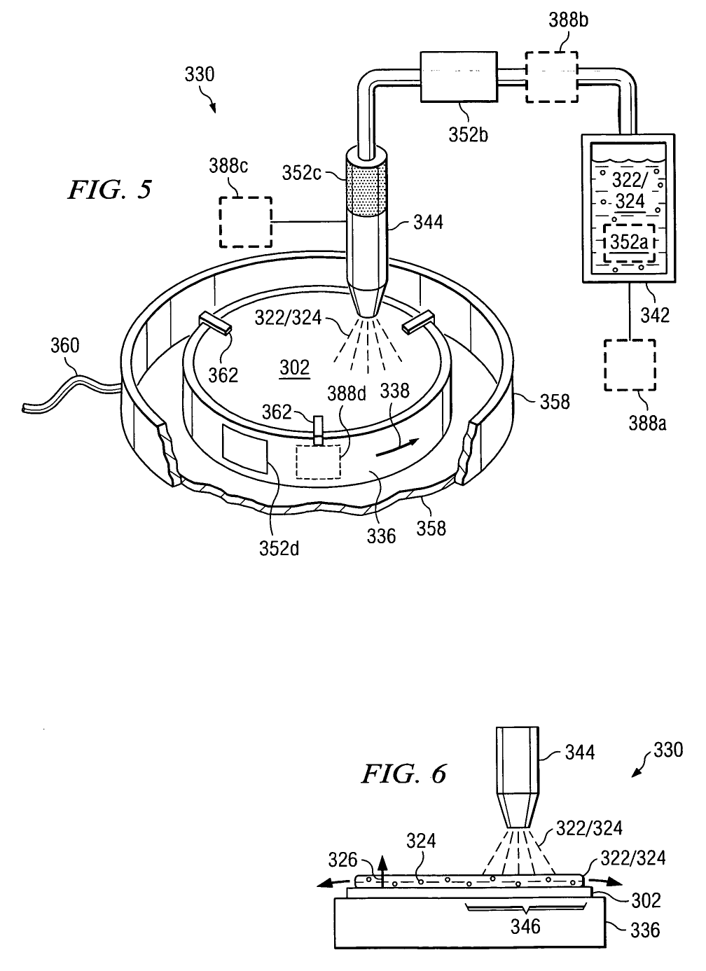

A means for dispensing the cleaning fluid 222/224 on at least a surface of the device 202 is preferably included within the chamber 232. For example, in the embodiment shown in FIG. 4, the means for dispensing the cleaning fluid 222/224 comprises a spray nozzle 244 proximate a support 236 adapted to support the device 202 disposed within the chamber 232. The support 236 may comprise a chuck for supporting the semiconductor device 202, for example. The chuck may be adapted to retain a semiconductor device 202 within the chuck, e.g., by a vacuum or by clamps disposed around a perimeter of the semiconductor device 202, for example (not shown in FIG. 4; see FIG. 5 at 362).

In this embodiment, the cleaning fluid 222/224 is preferably sprayed on the device 202 using the spray nozzle 244. For example, the device 202 may be rotated in a direction 238 while spraying the cleaning fluid 222/224 on the surface of the semiconductor device 202. The support 236 may be rotatable, e.g., using a motor coupled to the chuck (not shown). The rotational direction 238 of the support 236 is shown as counter-clockwise in FIG. 3; alternatively, the support 236 may also be rotated clockwise, for example.

The cleaning system 230 may include additional optional features, in some embodiments. For example, the cleaning system 230 may include an exit port 248 disposed near the bottom of the chamber 232 in which the cleaning takes place. As the cleaning fluid 222/224 is disposed on the device 202, excess cleaning fluid 222/224 flows off of the edges of the device 202 and into the bottom of the chamber 232. The excess fluid 222/224 drains out of the chamber 232 through the exit port 248.

The spray nozzle 244 may be adapted to be moved laterally across the surface of the device 202 over a lateral range 246. The lateral range 246 may comprise a range from the center of the device 202 to the edge of the device 202, as shown. Alternatively, the lateral range 246 may be over the entire diameter of the device 202, for example.

The cleaning system 230 may include a pressure control device 250a, 250b, 250c, or 250d located elsewhere in the system 230 in communication with (e.g., coupled to a portion of the cleaning fluid 222/224) the cleaning fluid 222/224, for example, shown in phantom. For example, the container 242 for the cleaning fluid 222/224 may be variably pressurized, and/or the chamber 232 may be variably pressurized to cause the release of the second component 224 from the cleaning fluid 222/224 as a gas. Alternatively, the cleaning fluid 222/224 may be pressurized by a pressure control device 250a or 250b coupled along the line, e.g., coupled to a tube or pipe that connects the container 242 to the chamber 232. The pressure control device 250a may be located close to the container 242 for the cleaning fluid 222/224 as shown in phantom, close to the chamber 232 in which the cleaning process takes place as shown in phantom at 250b, or in the chamber 232 proximate the spray nozzle 244, shown in phantom at 250c. Alternatively, the pressure control device 250d may be included in the spray nozzle, shown in phantom at 250d.

Note that the chamber 232 may not be required if a pressure control device 250a, 250b, 250c, and/or 250d is included, or if the container 242 for the cleaning fluid 222/224 is used to vary the pressure of the cleaning fluid 222/224 in accordance with embodiments of the present invention. One or more devices, e.g., the container 242, the chamber 232, and/or pressure control devices 250a, 250b, 250c, or 250d may be used to vary the pressure of the cleaning fluid 222/224 and cause release of the second component 224 as a gas, for example.

FIG. 5 illustrates a cleaning system 330 in accordance with another embodiment of the present invention, wherein an increase in temperature may be used to cause the second component 324 to be released as a gas from the cleaning fluid 322/324. Like numerals are used for the various elements that were described in FIGS. 3 and 4, and to avoid repetition, each reference number shown in FIG. 5 is not described again in detail herein. Rather, similar materials x22, x24, x44, etc. . . . are preferably used for the various materials and devices shown in FIG. 5 as were used to describe FIGS. 3 and 4, where x=2 in FIGS. 3 and 4 and x=3 in FIG. 5. As an example, the preferred and alternative materials for the first and second components 222 and 224 of the cleaning fluid 222/224 in the description for FIGS. 3 and 4 are preferably also used for the first and second components 322 and 324 of the cleaning fluid in FIG. 5.

The cleaning system 330 preferably includes a heater 352a, 352b, 352c and/or 352d adapted to heat the cleaning fluid 322/324, for example. The heater 352a, 352b, 352c and/or 352d comprises the gas-releasing device in this embodiment. The heater 352a, 352b, 352c and/or 352d is used to increase the temperature of the cleaning fluid 322/324, which causes a release of at least a portion of the second component 324 of the cleaning fluid 322/324 as a gas.

The heater 352a, 352b, 352c and/or 352d may be coupled to or located within the container 342 for the cleaning fluid 342, as shown at 352a in phantom. The heater 352a, 352b, 352c and/or 352d may be located along the line or tube carrying the cleaning fluid 322/324 to the spray nozzle 344, as shown 352b. The heater 352a, 352b, 352c and/or 352d may be coupled to or integral with the spray nozzle 344, as shown at 352c. The heater 352a, 352b, 352c and/or 352d may be coupled to or integral with the support 336, as shown at 352d. One or more heaters 352a, 352b, 352c and/or 352d may be included in the cleaning system 330, for example.

The heater 352a, 352b, 352c and/or 352d is preferably adapted to increase the temperature of the cleaning fluid 322/324 by an amount sufficient to cause a portion of the second component 324 to be released from the cleaning fluid 322/324 as a gas. The cleaning fluid 322/324 may initially be at room temperature, and the temperature of the cleaning fluid 322/324 may be raised by about 10 degrees C. or greater using the heater 352a, 352b, 352c and/or 352d, for example. Alternatively, the cleaning fluid 322/324 may initially be at a temperature less than room temperature, e.g., the container 342 may be coupled to a heat exchanger (e.g., 352a may comprise a heat exchanger) adapted to cool the cleaning fluid 322/324, for example. One or more heaters 352a, 352b, 352c and/or 352d may be used to increase the temperature of the cleaning fluid 322/324 to a temperature of room temperature or greater, for example, in this embodiment.

Note that the cleaning system 330 may include a chamber (not shown in FIG. 5; see chamber 232 in FIG. 4) in which the cleaning method takes place. Alternatively, the cleaning system 330 may take place in an open vat or tray 358, as shown in FIG. 5. The vat 358 preferably includes an exit port 360 adapted to drain off the excess cleaning fluid 322/324 during and after the cleaning process. The support 336 may include two or more clamps 362 for retaining the device 302 on the support 336, in this embodiment, as shown.

FIG. 6 shows a cross-sectional view of a portion of the cleaning system 330 shown in FIG. 5. The semiconductor device 302 comprises a first side and a second side opposing the first side. FIG. 6 illustrates the lateral movement of the spray nozzle 344 at 346. The spray nozzle 344 may move from left to right, starting at the center of the device 302 while spraying the cleaning fluid 322/324 on the device 302, and continuing to spray the cleaning fluid 322/324 on the device 302 while moving towards the edge of the device 302. The spray nozzle 344 is then moved repeatedly from the edge to the center, and back to the edge of the device 302. The support 336 may rotate the device 302 continually while the cleaning fluid 322/324 is sprayed on the device 302, creating lateral movement of the cleaning fluid 322/324 from the center to the edge of the device 302. The cleaning fluid 322/324 is then drained the exit port 360 (see FIG. 5). Thus, the cleaning fluid 322/324 is laterally flown from the first side to the second side of the semiconductor device 302, which facilitates the cleaning of the device 302 by continual replacement of the cleaning fluid 322/324. The debris is carried away upwardly within the cleaning fluid 322/324 by the convection-like flow 326 created by the second component 324 as it is released by a gas from the cleaning fluid 322/324.

FIG. 7 shows a cleaning system 470 in accordance with yet another embodiment of the present invention, wherein the cleaning fluid 422/424 is applied on a surface of a device 402 by immersing the device 402 in a container 472 filled with the cleaning fluid 422/424. Again, like numerals are used for the various elements that were used to describe the previous figures, and to avoid repetition, each reference number shown in FIG. 7 is not described again in detail herein.

The cleaning system 470 includes a container 472 comprising a tank for containing the cleaning fluid 422/424. One or more devices 402 to be cleaned are placed in a support for at least one device 402 comprising a cartridge 474 which is then submersed in the tank 472. The cartridge 474 is preferably adapted to hold one or more devices 402, and may be adapted to hold about 25 devices 402 or semiconductor wafers in one embodiment, as an example. Advantageously, two or more devices 402 may be cleaned simultaneously in the cleaning system 470 shown in FIG. 7, for example.

The cleaning fluid 422/424 may not be moved laterally across a surface of the device 402 or devices 402 being cleaned in this embodiment. For example, the cleaning fluid 422/424 may be stationary within the tank 472. The release of the second component 424 from the cleaning fluid 422/424 creates a convection-like process that cleans features of the device 402, in this embodiment. Alternatively, the cleaning fluid 422/424 may enter the tank 472 e.g., at the top from the container 442, and may exit the tank 472 e.g., at the exit port 448. The flow or movement of the cleaning fluid 422/424 in and out of the tank 472 is shown at 480, for example. The movement 480 of the cleaning fluid 422/424 assists in the cleaning of the device 402 or devices 402, in addition to the convection-like cleaning process of the release of the second component 424 from the cleaning fluid 422/424 as a gas, in this embodiment.

In the embodiment shown in FIG. 7, the cleaning process may take place in an optional chamber 432. In some embodiments, an optional gas supply may be coupled to the chamber 432, as shown at 478. The gas supply 478 may comprise a container of the second component 424 in gas form, for example. During the cleaning process, an additional amount of the gas comprising the second component 424 may be introduced into the chamber 432 while pressurizing the chamber 432, causing more of the second component 424 to dissolve in the first component 422 of the cleaning fluid 422/424. A pressure controller 476 adapted to control and adjust the pressure of the chamber 432 may be coupled to the chamber 432, as shown.

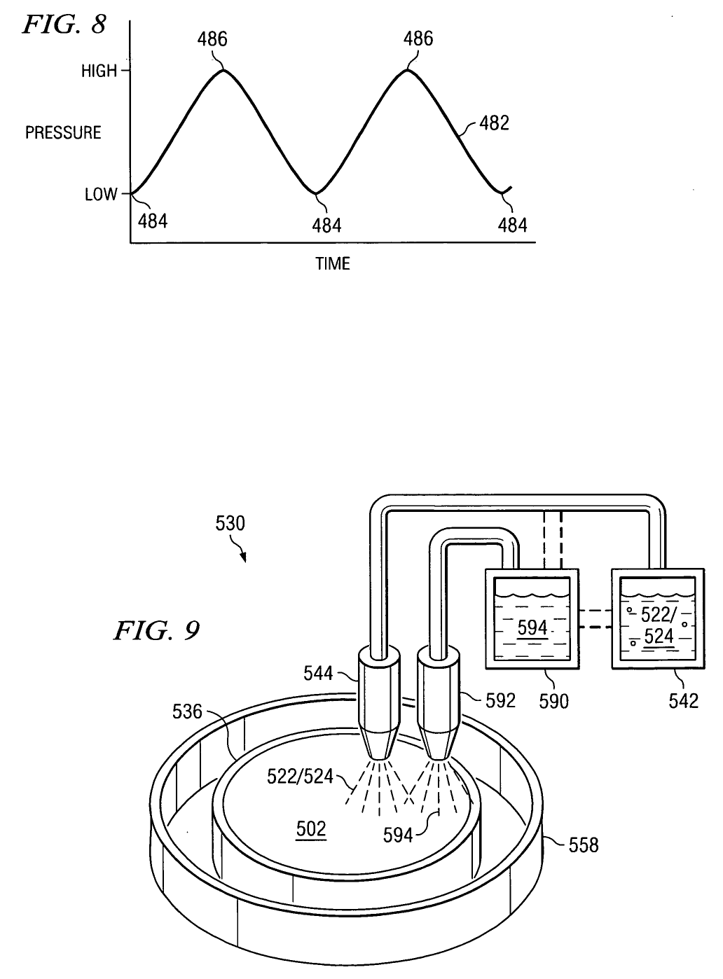

FIG. 8 is a graph 482 illustrating that the pressure of the cleaning process or the cleaning fluid 422/424 may be fluctuated to cause the second component 424 of the cleaning fluid 422/424 to be released from the cleaning fluid 422/424 as a gas alternatingly with being caused to return into the saturated solution of the cleaning fluid 422/424. Causing the second component 424 to be released from the cleaning fluid 422/424 as a gas and causing the second component 424 to re-dissolve in the first component 422 is periodically repeated, further facilitating cleaning of the device 402 with the cleaning fluid 422/424. This embodiment is preferably implemented in a pressurizable chamber 432, and one or more devices 402 are preferably cleaned by submerging the devices 402 in the cleaning fluid 422/424, in this embodiment.

The graph 482 illustrates that at low pressures 484, the bubbling, effervescent action of the release of the second component 424 as a gas from the cleaning fluid 422/424 is high, facilitating the cleaning process. At high pressures 486, the bubbling, effervescent action of the release of the second component 424 as a gas from the cleaning fluid 422/424 is low or is stopped, for example. Cycling the bubbling action further facilitates the cleaning process, in this embodiment.

Advantageously, the pressure may be cycled and an additional amount of the second component 424 may be added during the high pressure 486 cycles, or during the both the high pressure 486 and the low pressure 484 cycles, using the optional supply 478 of the second component 424 as a gas, for example. Thus, the gas supply 478 may be used to ensure that a sufficient amount of the second component 424 is dissolved in the cleaning fluid 422/424 to produce the bubbling action of the release of the second component 424 from the cleaning fluid 422/424, for example.

Note that in the cleaning systems 230, 330, and 470 shown in FIGS. 4, 5, and 7, respectively, an optional agitator may be implemented, as shown in phantom at 288a, 288b, 288c, and 288d; 388a, 388b, 388c, and 388d; and 488a, 488b, 488c, 488d, and 488e in FIGS. 4, 5, and 7, respectively. The agitators 288a, 288b, 288c, and 288d; 388a, 388b, 388c, and 388d; and 488a, 488b, 488c, 488d, and 488e may be adapted to cause the release of the second component 224, 324, and 424 from the cleaning fluid 222/224, 322/324, and 422/424 as a gas, for example. The optional agitators 288a, 288b, 288c, and 288d; 388a, 388b, 388c, and 388d; and 488a, 488b, 488c, 488d, and 488e shown in FIGS. 4, 5, and 7, respectively, may comprise sonic or megasonic devices adapted to cause movement or vibrations of the cleaning fluid 222/224, 322/324, and 422/424 at a predetermined frequency, e.g., at about 1 to 3 MHz, although other frequencies may also be used.

The optional agitators 288a, 288b, 288c, and 288d; 388a, 388b, 388c, and 388d; and 488a, 488b, 488c, 488d, and 488e are adapted to vibrate the cleaning fluid 222/224, 322/324, or 422/424 or devices of the cleaning systems 230, 330, or 470 that are in physical contact with the cleaning fluid 222/224, 322/324, or 422/424, which increases the molecular action or molecular energy within the cleaning fluid 222/224, 322/324, or 422/424, thus causing the release of the second component 224, 324, or 424 from the cleaning fluid 222/224, 322/324, or 422/424 as a gas, for example.

The optional agitators 288a, 288b, 288c, and 288d; 388a, 388b, 388c, and 388d; and 488a, 488b, 488c, 488d, and 488e may be coupled to or disposed within the container 242, 342, and 442 for the cleaning fluid 222/224, 322/324, or 422/424, as shown at 288a, 388a, and 488a, for example. The agitators 288a, 288b, 288c, and 288d; 388a, 388b, 388c, and 388d; and 488a, 488b, 488c, 488d, and 488e may be coupled to or between the line between the container 222/224, 322/324, or 422/424 for the cleaning fluid 222/224, 322/324, or 422/424 and the fluid dispensing device 244, 344, and 472, as shown at 288b, 388b, and 488b. The agitators 288a, 288b, 288c, and 288d; 388a, 388b, 388c, and 388d; and 488a, 488b, 488c, 488d, and 488e may be coupled to or contained within the fluid dispensing device 244, 344, and 472, as shown at 288c, 388c, and 488c. The agitators 288a, 288b, 288c, and 288d; 388a, 388b, 388c, and 388d; and 488a, 488b, 488c, 488d, and 488e may be coupled to the support 236, 336, and 474 for the device 202, 302, and 402, as shown at 288d, 388d, and 488d. The agitators 288a, 288b, 288c, and 288d; 388a, 388b, 388c, and 388d; and 488a, 488b, 488c, 488d, and 488e may also be coupled directly to the cleaning fluid 422/424, as shown at 488e, for example. Alternatively, the agitators 288a, 288b, 288c, and 288d; 388a, 388b, 388c, and 388d; and 488a, 488b, 488c, 488d, and 488e may be disposed elsewhere in the cleaning systems 230, 330, and 470 such as to cause agitation of the cleaning fluid 222/224, 322/324, or 422/424 and cause release of the second component 224, 324, and 424 as a gas, for example.

FIG. 9 shows a cleaning system 530 in accordance with another embodiment of the present invention, wherein an acid 594 is used to cause the second component 524 to be released as a gas from the cleaning fluid 522/524. In this embodiment, the acidity of the cleaning fluid 522/524 is changed to cause the second component 524 comprising a gas to be released from the cleaning fluid 522/524. In some embodiments, for example, the acidity of the cleaning fluid 522/524 is changed by introducing an acid 594 to the cleaning fluid 522/524. The acid 594 preferably comprises H₂SO₃, H₂SO₄, citric acid (e.g., C₆H₈O₇), lactic acid (e.g., C₃H₆O₃), formic acid (e.g., HCOOH), CH₃COOH, HCl, or aqueous solutions thereof, as examples, although alternatively, other chemicals adapted to alter the acidity of the cleaning fluid 522/524 of the system 530 may be used. When the acid 594 is added to the cleaning solution 522/524, an oversaturated solution is created that bubbles off the second component 524, which may comprise CO₂, for example. The acid 594 preferably comprises an acid 594 that is more acidic than H₂CO₃, (e.g., the cleaning fluid 522/524) in one embodiment, for example.

The cleaning system 530 includes a container 590 adapted to hold a supply of the acid 594. The container 590 may be coupled directly to the container 542 for the cleaning fluid 522/524, or may be coupled to the line between the container 542 for the cleaning fluid 522/524, as shown in phantom. The acid 594 is added to the cleaning fluid 522/524 before the cleaning fluid 522/524 reaches the device 502, in these embodiments. Alternatively, and more preferably in some embodiments, the acid 594 is added to the cleaning fluid 522/524 by spraying the acid 594 on the device 502 to be cleaned simultaneously when spraying the cleaning fluid 522/524 on the device 502, as shown, using an additional spray nozzle 592 to deliver the acid 594 on the device 502. The gas-releasing device that causes the second component 524 to be released as a gas from the cleaning fluid 522/524 comprises the acid 594, the container 590 of the acid 594, and/or the spray nozzle 592, for example, in this embodiment.

Note that embodiments of the present invention may be used in combinations thereof or alone. For example, one or more of the gas-releasing devices described herein may be implemented in a cleaning system. As an example, in the cleaning system 530 shown in FIG. 9, one or more agitators 288a, 288b, 288c, or 288d may be included, as shown in FIG. 4. A pressurizable chamber 232 and/or pressurizing devices 250a, 250b, 250c, or 250d may be included in the cleaning system 530, also shown in FIG. 4. One or more heaters 352a, 352b, 352c, or 352d may be included in the cleaning system 530, as shown in FIG. 5. The cleaning system 530 may comprise a fluid-dispensing device comprising a vat 472, as shown in FIG. 7.

Advantageously, existing cleaning systems may be used to implement some embodiments of the present invention; e.g., by using the novel cleaning fluids 222/224, 322/324, and 422/424 in a cleaning system having a pressurizable chamber and decreasing the pressure during the cleaning process, causing the second component 224, 324, and 424 to be released as a gas. Alternatively, in other embodiments, cleaning systems may be modified to add the heating devices, agitators, acid-introducing components, and/or pressurizing control devices and/or pressurizing chambers described herein, in order to implement the novel cleaning methods and systems of embodiments of the present invention.

Advantages of embodiments of the invention include providing novel cleaning fluids 222/224, 322/324, 422/424, and 522/524, cleaning systems 230, 330, 470, and 530, and cleaning methods 220 that are effective in cleaning material layers of semiconductor devices 202, 302, 402, and 502 and other types of devices having narrow features formed therein. When the second component 224, 324, 424, and 524 is caused to be released as a gas from the cleaning fluid 222/224, 322/324, 422/424, and 522/524, the bubbles of gas create an upward or vertical flow of the cleaning fluid 222/224, 322/324, 422/424, and 522/524, causing particles and debris to be removed from features. The bubbles of gas of the second component 224, 324, 424, and 524 transport particles or debris upwards from a plurality of trenches on a device 202, 302, 402, or 502, away from the surface of the device, upwards into a lateral flow of fluid across a surface of a device, for example.

Advantageously, the gas (e.g., the second component 224, 324, 424, and 524) may be caused to be released by several methods or combinations of methods, such as by decreasing the pressure, increasing the temperature, agitating the fluid, and/or introducing an acid. Embodiments of the present invention may advantageously be used in spray nozzle type cleaning systems or in tank tool cleaning systems. The cleaning fluids and methods are easily implementable in existing cleaning systems, by making slight modifications or adding additional features and components to cleaning systems, for example.

Although embodiments of the present invention and their advantages have been described in detail, it should be understood that various changes, substitutions and alterations can be made herein without departing from the spirit and scope of the invention as defined by the appended claims. For example, it will be readily understood by those skilled in the art that many of the features, functions, processes, and materials described herein may be varied while remaining within the scope of the present invention. Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed, that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

What is claimed is:

1. A method of cleaning, comprising:
providing a device;
disposing a cleaning fluid on the device, the cleaning fluid comprising a first component saturated with a second component, the first component comprising a liquid, the second component comprising a material that is releasable from the cleaning fluid as a gas; and
causing the second component to be released from the cleaning fluid while the cleaning fluid is disposed on the device.

2. The method according to claim 1, wherein causing the second component to be released from the cleaning fluid comprises decreasing a pressure, increasing a temperature, agitating the cleaning fluid or device, and/or changing an acidity of the cleaning fluid.

3. The method according to claim 1, wherein disposing the cleaning fluid comprises disposing a cleaning fluid having a top surface, wherein releasing the second component from the cleaning fluid forms a plurality of bubbles of the gas that move through the cleaning fluid in an upward direction towards the top surface of the cleaning fluid.

4. The method according to claim 3, wherein providing the device comprises providing a semiconductor workpiece comprising a surface having particles or debris formed thereon, and wherein the plurality of bubbles of gas collide with the particles or debris, moving the particles and/or debris in the upward direction.

5. The method according to claim 1, wherein disposing the cleaning fluid comprises disposing a cleaning fluid wherein the first component of the cleaning fluid comprises a soap, a detergent, a solvent, distilled water, deionized water, water, or combinations thereof, and wherein the second component comprises CO₂.

6. A method of cleaning a semiconductor device, the method comprising:
providing a cleaning fluid, the cleaning fluid comprising a first component and a second component dissolved in the first component;
providing a semiconductor device having a surface;
disposing the cleaning fluid on at least the surface of the semiconductor device; and
cleaning the surface of the semiconductor device with the cleaning fluid by causing the second component to be released from the cleaning fluid as a gas, wherein the gas comprises a plurality of upwardly rising bubbles that assist in the cleaning of the surface of the semiconductor device with the cleaning fluid.

7. The method according to claim 6, wherein disposing the cleaning fluid on at least the surface of the semiconductor device comprises immersing the semiconductor device in the cleaning fluid or spraying the cleaning fluid on the surface of the semiconductor device.

8. The method according to claim 6, wherein disposing the cleaning fluid on at least the surface of the semiconductor device comprises spraying the cleaning fluid on the surface of the semiconductor device, further comprising rotating the semiconductor device while spraying the cleaning fluid on the surface of the semiconductor device.

9. The method according to claim 6, further comprising causing the second component to re-dissolve in the first component, after causing the second component to be released from the cleaning fluid as a gas, and periodically repeating causing the second component to be released from the cleaning fluid as a gas and causing the second component to re-dissolve in the first component.

10. The method according to claim 6, wherein providing the cleaning fluid comprises placing the first component in a first chamber with a gas comprising the second component, and pressurizing the first chamber, causing the second component to dissolve in the first component.

11. The method according to claim 10, wherein cleaning the surface of the semiconductor device with the cleaning fluid takes place in a second chamber, wherein disposing the cleaning fluid on at least the surface of the semiconductor device and cleaning the surface of the semiconductor device with the cleaning fluid are performed in the second chamber, further comprising introducing an additional amount of the gas comprising the second component into the second chamber while pressurizing the second chamber during the cleaning of the surface of the semiconductor device, causing more of the second component to dissolve in the first component of the cleaning fluid.

12. A method of cleaning a semiconductor device, the method comprising:
providing a cleaning fluid, the cleaning fluid comprising carbon dioxide dissolved in a cleaning liquid or water;
providing a semiconductor device having a plurality of trenches formed on a surface thereof;
disposing the cleaning fluid at least on the surface of the semiconductor device; and
causing the carbon dioxide to be released from the cleaning fluid, cleaning the surface of the semiconductor device, wherein the carbon dioxide comprises a plurality of upwardly rising bubbles in the cleaning liquid or water that assist in cleaning of the surface of the semiconductor device by transporting particles or debris upwards from the plurality of trenches and from the surface of the semiconductor device.

13. The method according to claim 12, wherein the semiconductor device comprises a first side and a second side opposing the first side, further comprising laterally flowing the cleaning fluid from the first side to the second side of the semiconductor device.

14. The method according to claim 12, wherein causing the carbon dioxide to be released from the cleaning fluid comprises introducing an acid to the cleaning fluid.

15. The method according to claim 14, wherein introducing the acid comprises introducing H₂SO₃, H₂SO₄, citric acid, lactic acid, formic acid, CH₃COOH, HCl, or aqueous solutions thereof.

16. The method according to claim 12, wherein the providing the cleaning fluid comprises providing H₂CO₃.

17. A cleaning system, comprising:
a support for a device;
a cleaning fluid comprising a first component and a second component dissolved in the first component, the second component being releasable as a gas from the cleaning fluid;
a container for the cleaning fluid;
a means for dispensing the cleaning fluid on at least a surface of the device; and
a means for causing the second component to be released as a gas from the cleaning fluid.

18. The cleaning system according to claim 17, wherein the support for the device comprises a chuck and wherein the means for dispensing the fluid on at least the surface of the device comprises at least one spray nozzle; or wherein the support for the device comprises a cartridge adapted to support a plurality of devices, wherein the means for dispensing the fluid on at least the surface of the device comprises a tank for containing the cleaning fluid, and wherein the cartridge is submersible in the tank.

19. The cleaning system according to claim 17, further comprising a means for causing the gas to be re-dissolved in the cleaning fluid.

20. A cleaning system, comprising:
a support for at least one semiconductor workpiece;
a cleaning fluid comprising a first component and a second component dissolved in the first component, the second component being releasable as a gas from the cleaning fluid;
a container for the cleaning fluid;
a cleaning fluid dispenser; and
a gas-releasing device adapted to cause the second component to be released from the cleaning fluid as a gas.

21. The cleaning system according to claim 20, wherein the gas-releasing device comprises a pressurizable chamber, wherein the support for the at least one semiconductor workpiece and the cleaning fluid are disposable within the pressurizable chamber, and wherein the gas is releasable from the cleaning fluid by decreasing a pressure of the pressurizable chamber.

22. The cleaning system according to claim 21, further comprising a gas supply of the second component coupled to the pressurizable chamber, wherein the second component is introducible in gas form into the pressurizable chamber when the at least one semiconductor workpiece is cleaned.

23. The cleaning system according to claim 20, wherein the gas-releasing device comprises a pressure control device in communication with the cleaning fluid.

24. The cleaning system according to claim 20, wherein the gas-releasing device comprises a heater coupled to the support for the at least one semiconductor workpiece, the cleaning fluid, the container for the cleaning fluid, or the cleaning fluid dispenser.

25. The cleaning system according to claim 20, wherein the gas-releasing device comprises a supply of an acid proximate the support for the at least one semiconductor workpiece, the cleaning fluid, or the container for the cleaning fluid.

26. The cleaning system according to claim 20, wherein the gas-releasing device comprises an agitator coupled to the support for the at least one semiconductor workpiece, the cleaning fluid, or the container for the cleaning fluid.
